(19) United States
(12) Patent Application Publication
(10) Pub. No.: US 2020/0120081 A1
(43) Pub. Date: Apr. 16, 2020

(54) USER AUTHENTICATION BASED ON BIOMETRIC PASSWORDS

(71) Applicant: CA, Inc., New York, NY (US)

(72) Inventors: Anil Kumar Sutrala, Hyderabad (IN); Dayakar Reddy Venkivolu, Hyderabad (IN); Jagan Kona, Hyderabad (IN)

(21) Appl. No.: 16/157,877

(22) Filed: Oct. 11, 2018

(51) Int. Cl. H04L 29/06; G06F 21/46; H04L 9/06; H04L 9/32

(52) U.S. Cl. CPC H04L 63/083; H04L 63/0861; H04L 63/0884; H04L 9/0643; H04L 9/3231; G06F 21/46

(57) ABSTRACT

Techniques are disclosed relating to user authentication based on biometric passwords. In some embodiments, a client device receives, from a user, user input that includes one or more character-values and one or more biometric readings provided in a particular sequence. The client device may then generate a biometric password based on the user input. In some embodiments, generating the biometric password includes generating a biometric value for each of the one or more biometric readings and combining the one or more character values and the biometric values in an order that corresponds to the particular sequence to generate the biometric password. The client device may then send, to a server system, an authentication request to authenticate the user to a service, where the authentication request includes the biometric password.

### BACKGROUND

### Technical Field

This disclosure relates generally to data security, and more particularly to authenticating a user based on one or more biometric passwords.

### Description of the Related Art

Server systems, such as web servers, application servers, etc., may provide various computing resources to an end user. For example, an application server may provide access to software applications to various remote users via a network. A server system will commonly limit access to its resources to only authorized end users. One method of limiting access is to require end users to provide credentials, such as a username and password, to the server system. The server system then uses the credentials to authenticate the requesting end user prior to providing access to the resource. In some instances, however, such credentials may be vulnerable to discovery by an unauthorized third-party (e.g., through a brute-force attack, etc.), presenting security concerns. Thus, in various instances, it may be desirable to implement a user-authentication technique that limits the vulnerability of the credential to discovery by unauthorized third-parties without compromising the convenience of the user experience.

### SUMMARY

Techniques are disclosed relating to user authentication based on biometric passwords. In some embodiments, a client device receives, from a user, user input that includes one or more character-values and one or more biometric readings provided in a particular sequence. The client device may then generate a biometric password based on the user input. In some embodiments, generating the biometric password includes generating a biometric value for each of the one or more biometric readings where, for a given biometric reading, a corresponding biometric value is a string of one or more character-values generated based on the given biometric reading. Further, in some embodiments, generating the biometric password includes combining the one or more character-values and the biometric values in an order that corresponds to the particular sequence to generate the biometric password. The client device may then send, to a server system, an authentication request to authenticate the user to a service, where the authentication request includes the biometric password.

### BRIEF DESCRIPTION OF THE DRAWINGS

FIG. 1 is a block diagram illustrating an example system for authenticating an end user to a service, according to some embodiments.

FIG. 2 is a block diagram illustrating an example client device and authentication application, according to some embodiments.

FIG. 3 is a block diagram illustrating an example authentication server, according to some embodiments.

FIG. 4 is a flow diagram illustrating an example method, performed by a client device, for a user of the client device to register to use an authentication service provided by an authentication server, according to some embodiments.

FIG. 5 is a flow diagram illustrating an example method, performed by a client device, for generating a biometric password for use in user authentication, according to some embodiments.

FIG. 6 is a block diagram illustrating an example method for generating a biometric password based on user input, according to some embodiments.

FIG. 7 is a block diagram illustrating an example computer system, according to some embodiments.

### DETAILED DESCRIPTION

Server systems implement various authentication techniques in an effort to limit unauthorized access to computing resources. One common authentication technique is to require a requesting user to provide a password (such as an alphanumeric string, PIN code, or any other suitable credential) that may be validated against a stored password for the user. This authentication technique presents various security concerns.

For example, given the ubiquity of the Internet and the increasingly common use of web services, a given person is often required to establish an account, and corresponding password, for various web sites or web services (e.g., email, streaming service accounts, bank accounts, etc.). Accordingly, in many instances, a given user may have many such accounts, each of which requiring its own password that the user must provide prior to gaining access to the website or web service.

Because they are required to remember numerous passwords, it is common for users to establish passwords that are easy to remember (e.g., “password,” “12345,” etc.) or establish the same password across multiple services, rather than memorize a different password for each different service. Unfortunately, however, both of these practices present significant data-security concerns. For example, passwords that are easy to remember may be particularly prone to discovery through brute-force, password-guessing attacks, which have become increasingly effective with the increased processing capabilities of modern computing systems. To protect passwords from such attacks, some websites and web services enforce policies specifying minimum requirements for valid passwords, such as password length (e.g., at least 8 characters) or password content (e.g., use of an uppercase letter, lower case letter, number, special character, etc.). For example, a user may establish the string “1IO8&amb2” as a password that satisfies such a policy. While these policies may make a user's password marginally more secure, such passwords are still susceptible to discovery through a brute-force attack. Additionally, such passwords may be more difficult to remember than a shorter password that does not comply with the imposed password policies. Thus, any security benefits provided by such policies are often considerably outweighed by the increased burden on the user to remember and enter a password that complies with the policies.

Using the same credentials for multiple different web services also presents significant data-security concerns. For example, the server (or authentication server) for the website or web service typically stores the user's password so that it may be used to verify the password provided by a requesting user. Storing the user's password at the server, however, may make the password vulnerable to discovery by unauthorized third-parties. For example, the server storing the user's password may be the target of a data breach in which the passwords for one or more authorized users are compromised. In such an instance, having obtained the authorized user's password, an unauthorized third-party may be able to access the service to the same extent as the authorized user, thus exposing potentially sensitive information and functionality to the unauthorized third party. This data-security problem is further exacerbated in instances in which the same credential is used across multiple different services. In such cases, the compromise of the user's password for any one of the services compromises the security of the user's accounts for all services that share the same password, leaving such accounts susceptible to unauthorized access by an unauthorized third-party. Thus, existing user-authentication systems present various technical shortcomings, compromising both data security and the user experience.

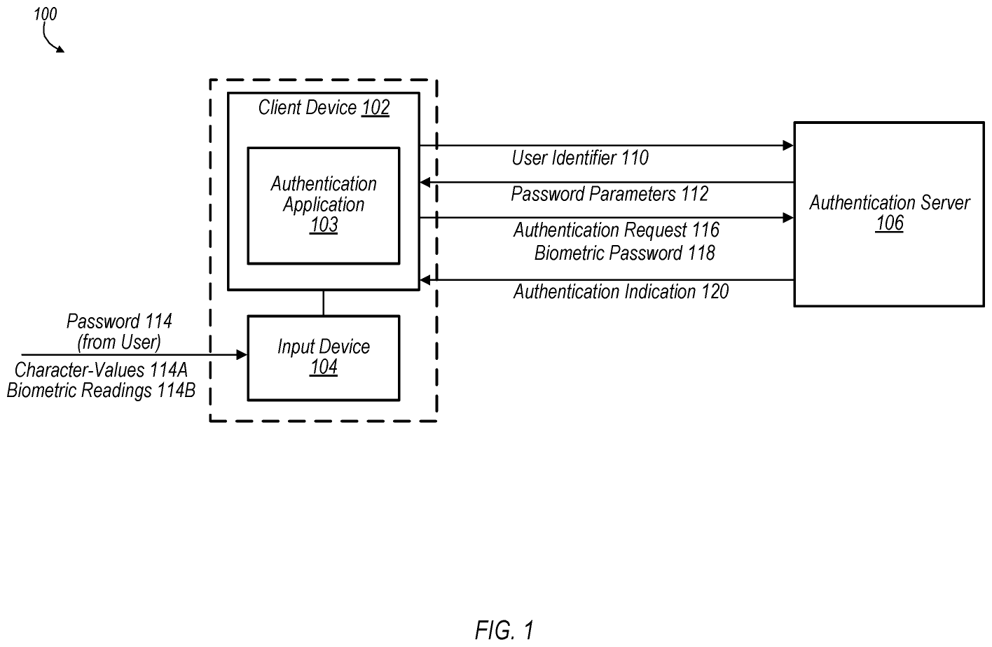

Referring now to FIG. 1, a block diagram illustrating a system 100 for authenticating a user to a server system is depicted, according to some embodiments. In the embodiment of FIG. 1, system 100 includes client device 102 and authentication server 106. In various embodiments, authentication server 106 may be configured to authenticate a user of client device 102 to a service provided by a server system 108 (not shown for clarity). For example, server system 108 may host a web service, such an email service, streaming service, etc., that a user of client device 102 attempts to access. In response to an access attempt, server system 108 may delegate user-authentication operations to authentication server 106, which may authenticate the user based on a biometric password generated by the client device 102 using one or more biometric readings of the user combined with one or more character-values, as described in more detail below.

In the depicted embodiment, client device 102 is in communication with input device 104. As indicated in FIG. 1, input device 104 may be either included as part of client device 102 or a separate component that is communication with client device 102 using any suitable communication technique (e.g., Bluetooth, NFC, USB, etc.). For example, in some embodiments, client device 102 may be a computing device (e.g., smartphone, tablet, laptop, etc.) that has (or has access to) both a keyboard (real or virtual) and one or more biometric sensors (e.g., fingerprint sensors, cameras operable to perform facial recognition or iris scans, etc.).

As shown in FIG. 1, client device 102 includes authentication application 103. In various embodiments, authentication application 103 is operable to generate a biometric password 118 based on input from the user and one or more password parameters 112. For example, in various embodiments, a user of client device 102 provides a password 114 via one or more input devices 104. In various embodiments, the password 114 includes both character-values 114A and one or more biometric readings 114B provided in a particular sequence. As used herein, the term “character-values” refers to any of various characters that may be input by a user via a keyboard or other input device, including alphabetic characters, numeric characters, punctuation marks (e.g., “!,” “?,” etc.), mathematical symbols (e.g., “+,” “−,” etc.), or any other character or symbol (e.g., “$,” “%,” “#,” etc.). For example, in one embodiment, the password 114 may be provided as follows: the character-value “f,” the biometric reading of the user's right index finger—BIO_{R Index}, the biometric reading of the user's right ring finger—BIO_{R Ring}, the character-value “s,” the biometric reading of the user's left thumb—BIO_{L Thumb}, and the character-value “1.” In this particular example, the password 114 includes six entries—three alphanumeric character-values (“f,” “s,” and “1”) and three biometric readings (fingerprints corresponding to the user's right index finger, right ring finger, and left thumb). In practice, such a password 114 may be easy for the user to remember as it is short and loosely corresponds to an easily remembered phrase, “first one.” Using the disclosed techniques, however, authentication application 103 may use this short password 114, including character-values 114A and biometric readings 114B, to generate a biometric password 118 that is much longer and more secure than a password based on existing password policy systems, described above.

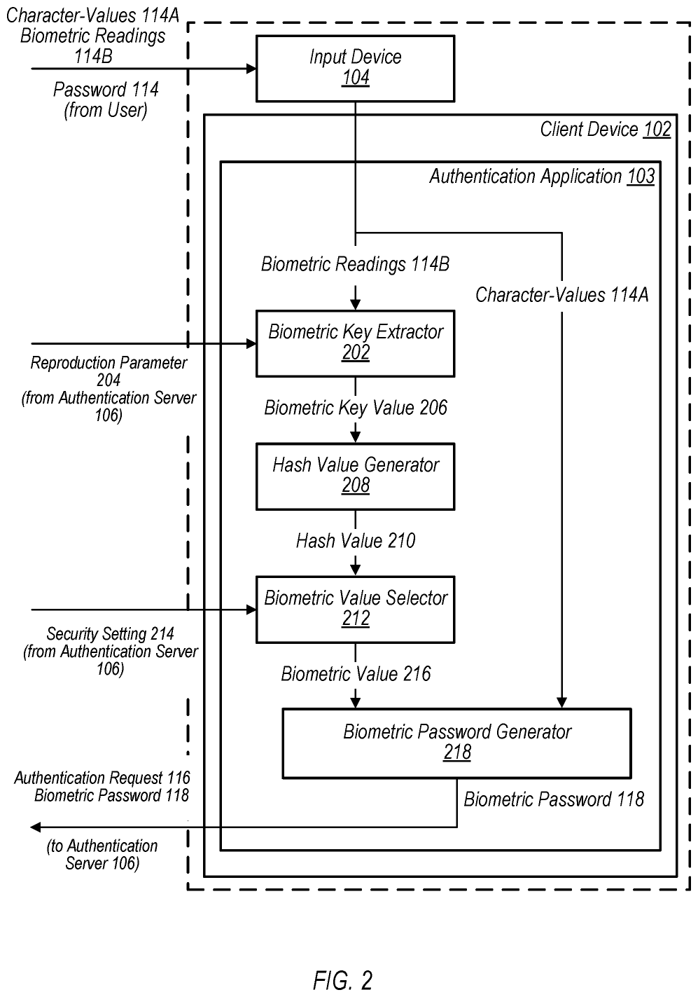

In the depicted embodiment, client device 102 sends, to authentication server 106, a message that specifies a user identifier 110 (e.g., a username) associated with the user for the service provided by server system 108. Note that, in various embodiments, client device 102 may also include an identifier that indicates the service that the user is attempting to access. In response, in various embodiments, the authentication server 106 may provide one or more password parameters 112 to client device 102. As described in more detail below with reference to FIG. 2, authentication application 103 may be operable to generate biometric password 118 based on the password 114 and, in various embodiments, one or more of the password parameters 112. In various embodiments, for example, authentication application 103 is operable to generate a biometric value for each of the one or more biometric readings 114B included in password 114, where, for a given biometric reading 114B, the corresponding biometric value includes a string of one or more character-values. For example, given a fingerprint reading for a user's right index finger, authentication application 103 may generate a corresponding biometric value that includes a string of one or more character-values. The number of character-values included in a biometric value may vary by embodiment. For example, in some embodiments, a biometric value may include 64, 128, 256, 512, etc. bits. In various embodiments, authentication application 103 may combine the one or more character-values 114A with the one or more biometric values (which, as noted, may each be a string of character-values generated based on the biometric readings 114B) to generate the biometric password 118.

In various embodiments, client device 102 may send, to the authentication server 106, an authentication request 116 to authenticate the user of client device 102 to a service provided by server system 108. As shown in FIG. 1, the authentication request 116 may include biometric password 118, which authentication server 106 may use to determine whether to authenticate the user to the service. Based on this determination, authentication server 106 may send an authentication indication 120 to the client device 102 or server system 108, indicating whether the user is authenticated to the service. If the authentication indication 120 indicates that the user is authenticated, server system 108 may provide access to the service or website to the user of client device 102. If, however, the authentication indication 120 indicates that the user is not authenticated, server system 108 or authentication server 106 may be operable to take one or more corrective actions, such as denying the user access to the service and initiating further authentication operations.

The present disclosure addresses technical problems in the field of user authentication. More specifically, the disclosed systems and method, in at least some embodiments, address data-security concerns associated with conventional passwords used for user-authentication. As noted above, conventional passwords that are shorter and easier to remember may be particularly vulnerable to discovery by an unauthorized third-party, for example through a brute-force attack. Further, passwords that are made longer to comply with password policies are often more difficult for users to remember while offering little security improvement.

Various embodiments of the present disclosure, however, provide a technical solution to these technical problems, thereby improving data-security and the authentication process as a whole. For example, various disclosed embodiments allow for user authentication based on longer, more secure biometric passwords without requiring the user to remember a long, complicated series of character-values. As described herein, these biometric passwords may be generated based on a relatively short series of character-values and biometric readings and may result in a much longer, more-secure password. Consider, for example, the six-entry password 114 mentioned above: “f,” BIO_{R Index}, BIO_{R Ring}, “s,” BIO_{L Thumb}, and “1.” In an embodiment in which each of the biometric values is 64 character-values in length (e.g., a 512 bit value represented as a string of 8-bit ASCII characters), the resulting biometric password 118 would be 195 character-values in length. Thus, a biometric password 118 generated according to embodiments of the disclosed systems and method will be much longer and more resistant to brute-force attacks than a password that could be conveniently remembered or entered by a user when attempting to access a website or service.

Further, in various embodiments, the disclosed systems and methods improve data-security by performing two-factor user authentication based on the biometric password 118. That is, in various embodiments, password 114 may be seen as requiring two factors from the user-what the user knows (the character-values 114A and biometric readings 114B used and their sequence within password 114) and what the user has (the sources of the biometric readings). Additionally, in various embodiments, the disclosed systems and methods may advantageously store the biometric password 118 at the authentication server as one series of character-values, without specifying which character-values correspond to which biometric sources or readings. In various embodiments, such an approach ensures that, if the biometric passwords 118 were ever compromised at the authentication server 106, a third-party would not be able to differentiate between those values that are part of the character-values 114A and those character-values that were generated based on a biometric reading 114B, allowing the user to securely re-use the same biometric sources for subsequent biometric passwords.

Turning now to FIG. 2, a block diagram illustrating an example client device 102 and authentication application 103 is shown, according to some embodiments. As described in more detail below, authentication application 103 is operable, in various embodiments, to receive password 114, including character-values 114A and biometric readings 114B, from a user and generate a biometric password 118 to be sent to authentication server 106.

Client device 102 may be any suitable computing device, such as a desktop computer, laptop computer, smartphone, tablet, etc. As shown in FIG. 2, client device 102 may include (or have access to) input device 104, which is configured to receive a password 114, including one or more character-values 114A and one or more biometric readings 114B, from a user. For example, in some embodiments, client device 102 may be any suitable computing device that has (or has access to) one or more input devices 104 that include a keyboard, to receive one or more character-values 114A, and one or more biometric sensors (e.g., fingerprint scanner, cameras, etc.) to receive one or more biometric readings 114B. Note that, in some embodiments, biometric readings 114B may include readings for various types or combinations of biometric values, such as fingerprints, facial patterns, retinal patterns, iris patterns, or any other suitable biometric reading. For example, in one embodiment, authentication application 103 may be operable to generate biometric passwords 118 based on both a user's fingerprints and a user's facial pattern. In such an embodiment, password 114 may include biometric readings 114B for both one or more fingerprints and a facial pattern.

In the depicted embodiment, authentication application 103 includes biometric key extractor 202. In various embodiments, biometric key extractor 202 is operable to generate, for each of the biometric readings 114B in password 114, a corresponding biometric key value 206. Biometric key extractor 202 may generate biometric key value 206 using various suitable techniques. For example, in some embodiments, biometric key extractor 202 uses fuzzy extractors to generate the biometric key values 206 based on the biometric readings 114B.

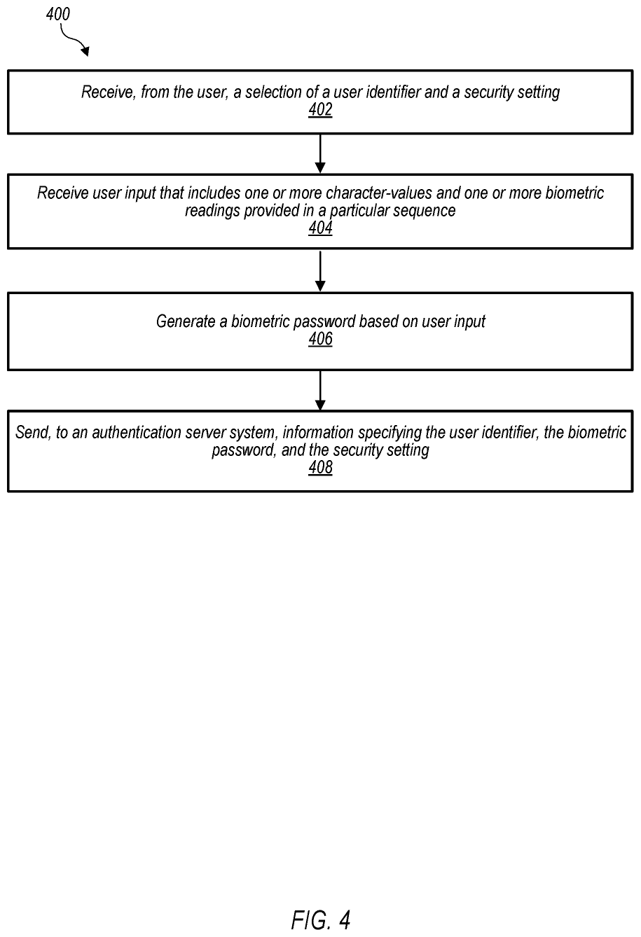

As will be appreciated by one of skill in the art with the benefit of this disclosure, fuzzy extractors may be used to convert biometric data, such as a biometric reading 114B, into strings of character-values (e.g., alphanumeric values). In various disclosed embodiments, these strings may be used to generate biometric passwords 118 for use in user authentication. As will be described in more detail with reference to FIG. 4, during an initial registration phase of the disclosed systems and methods, the fuzzy extractor technique may be used to generate a biometric key value 206 and reproduction parameter 204 pair for each biometric reading 114B in a password 114. That is, during the registration phase, biometric key extractor 202, in various embodiments, takes a given biometric reading 114B and uses a fuzzy extractor probabilistic generation function to generate a biometric key value 206 and a corresponding reproduction parameter 204. As will be appreciated by one of skill in the art with the benefit of this disclosure, a reproduction parameter 204, in various embodiments, is a string that may be used to reproduce a biometric key value 206 for a given biometric reading 114B. For example, in various embodiments, the biometric key extractor 202 may use the fuzzy extractor deterministic reproduction function (e.g., during authentication) to generate the key value 206 based on a biometric reading 114B using the associated reproduction parameter 204.

For example, assume that a password 114 includes a fingerprint for a user's right index finger (BIO_{R index}). During the registration phase, biometric key extractor 202 may generate (e.g., using the fuzzy extractor generation function) a pair of values—a biometric key value 206 and corresponding reproduction parameter 204—based on the fingerprint for the user's right index finger. A biometric key value 206 and corresponding reproduction parameter 204 pair may similarly be generated for each biometric reading 114B included in the password 114. Subsequently, during an authentication phase (as shown in FIG. 2), the user may again scan the fingerprint of his right index finger as part of providing the password 114. In this example, the biometric key extractor 202 may reproduce (e.g., using the fuzzy extractor reproduction function) the same biometric cryptographic key 206 based on a new fingerprint for the right index finger of the user using the reproduction parameter 204. The biometric key extractor 202 may similarly reproduce the keys values 206 for each of the biometric readings 114B in the password 114 using the corresponding reproduction parameters 204. As will be appreciated by one of ordinary skill in the art with the benefit of this disclosure, reproduction parameters, in some instances, are public in nature and may be made public without compromising the security of their corresponding biometric cryptographic key values.

Note, however, that the fuzzy extractor reproduction function, in various instances, is only able to reproduce a key value 206 using a corresponding reproduction parameter 204 for a given reading 114B if the difference between the initial reading 114B for a given biometric source (e.g., fingerprint for the right index finger) and the subsequently provided reading 114B for that same source is within a particular tolerance threshold (e.g., if the Hamming distance between BIO_{R Index} and BIO_{R Index}′ is less than or equal to an error tolerance et).

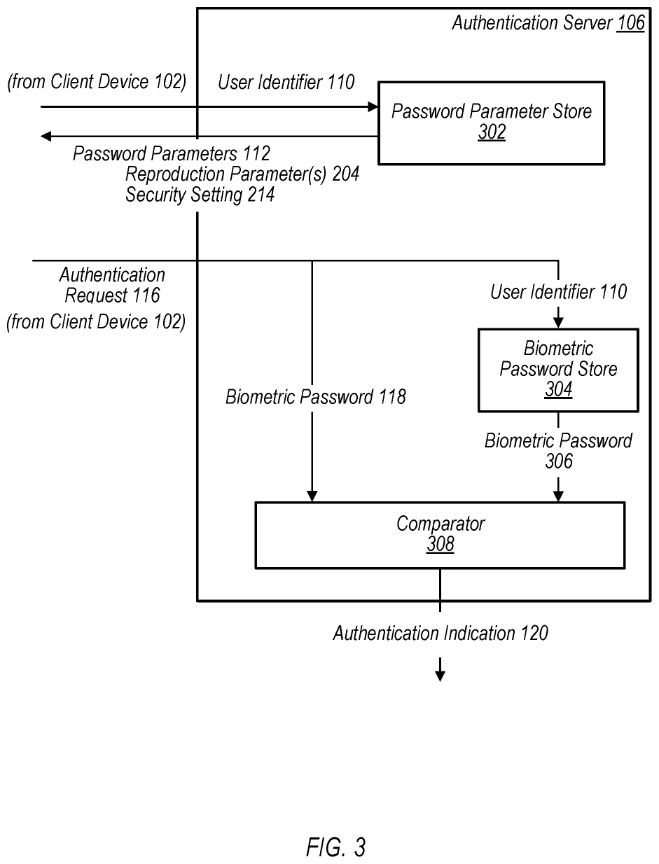

Reproduction parameters 204 may, in various embodiments, be stored locally on client device 102 or sent to client device 102 during authentication. In the depicted embodiment, for example, client device 102 sends, during authentication, a message to authentication server 106 that includes a user identifier 110. As described in more detail below with reference to FIG. 3, authentication server 106 may use this user identifier 110 to retrieve the reproduction parameters 204 associated with the user for the service and send the reproduction parameters 204 to the client device 102. In the event that password 114 includes more than one biometric reading 114B, the corresponding reproduction parameters 204 may be stored by, or sent to, client device 102 as a vector in which the order of the parameters 204 in the vector is the same as the order of the corresponding biometric readings 114B in the password 114. For example, consider an instance in which the password 114 includes three biometric readings 114B—a left pinky fingerprint, a facial pattern, and a right pinky fingerprint, in that order. In such an instance, the reproduction parameters 204 may be stored by, or sent to client device 102 as, a vector that includes three reproduction parameters 204—a first parameter corresponding to the biometric key for the left pinky fingerprint, a second parameter corresponding to the biometric key for the facial pattern, and a third parameter corresponding to the biometric key for the right pinky fingerprint.

Authentication application 103 further includes hash value generator 208, which, in various embodiments, is operable to generate a hash value 210 based on biometric key value 206. In various embodiments, hash value generator 208 may use any suitable hash function or functions to generate hash values 210, such as SHA-2, MD5, etc. In various embodiments, hash value 210 is generated as a string of character-values. Note that, in various embodiments, the length of hash value 210 may vary depending on the hash function utilized by hash value generator 208. For example, in embodiments in which the hash function SHA-256 is used, the hash value 210 will be 256 bits in length. This embodiment is provided merely as an example, however, and hash value 210 may be any suitable length (e.g., 128 bits, 512 bits, etc.) in various embodiments.

Authentication application 103 further includes biometric value selector 212, which, in various embodiments, is operable to select a biometric value 216 from hash value 210. For example, in some embodiments, biometric value selector 212 may select a subset of hash value 210 as the biometric value 216.

As with hash value 210, the length of biometric value 216 may vary according to different embodiments. In some embodiments, the length of biometric value 216 may be based on a security setting 214 selected by a user during the initial registration phase. For example, in some embodiments, the user, during registration, is presented with an option to select one of multiple security levels (e.g., low/high, low/medium/high, etc.) for authentication to the service provided by server 108. In such embodiments, the length of biometric value 216 may depend on the security level selected by the user, with the length of biometric value 216 increasing as the chosen level of security increases. For example, consider an embodiment in which hash value 210 is 512 bits long and the user is presented with an option to select between a lower security setting, a medium security setting, and a higher security setting during the registration process. In such an embodiment, selection of the lower security setting 214 may cause biometric value selector 212 to select biometric values 216 that are 64 bits in length, selection of the medium security setting 214 may cause biometric value selector 212 to select biometric values 216 that are 128 bits in length, and selection of the higher security setting 214 may cause biometric value selector 212 to select biometric values 216 that are 256 bits in length. Note, however, that this embodiment is provided merely as an example and is not intended to limit the scope of the present disclosure.

Note that, in some instances, the user authentication process may take marginally longer to perform when longer biometric values 216 are used, e.g., due to increased processing time. Accordingly, in some embodiments, this ability to select a security setting 214 allows the user to choose between increased convenience (e.g., through faster authentication) and increased security (e.g., through longer biometric values 216 and, ultimately, longer biometric passwords 118). In some embodiments, however, biometric value selector 212 may select biometric value 216 without reliance on any security setting 214. For example, in some embodiments, biometric value selector 212 may be operable to select a given number of bits or character-values from hash value 210 as the biometric value 216 and not require the user to select a security setting 214 during the initial registration phase. In other embodiments, biometric value selector 212 may select biometric value 216 based on a security setting 214 associated with the particular service to which the user of client device 102 is attempting to access.

Biometric value selector 212 may select biometric value 216 from hash value 210 using any one of various suitable techniques. For example, in some embodiments, biometric value selector 212 may select biometric value 216 by truncating the hash value 210 to a particular length based on the selected security level, as discussed above. In such embodiments, biometric value selector 212 may select biometric value 216 as the first predetermined number of character-values in hash value 210, the last predetermined number of character-values in hash value 210, as some selection of the predetermined number of character-values within the middle of hash value 210, etc. In other embodiments, biometric value selector 212 may select biometric value 216 using any other suitable technique. For example, in some embodiments, biometric value selector 212 may select biometric value 216 by selecting the predetermined number of character-values from hash value 210 using one or more predetermined patterns or algorithms.

Authentication application 103 further includes biometric password generator 218, which, in various embodiments, is operable to combine the one or more character-values 114A with the biometric values 216 (e.g., through concatenation) to generate the biometric password 118. In various embodiments, biometric password generator 218 may combine the character-values 114A and the biometric values 216 in an order that corresponds to the particular sequence in which character-values 114A and biometric readings 114B were provided in the password 114. In other embodiments, however, rather than being combined in an order that corresponds to the sequence in which they were provided, character-values 114A and biometric values 216 may be combined according to any suitable pattern or algorithm.

Once generated by the authentication application 103, biometric password 118 may be output such that client device 102 may send it, as part of an authentication request 116, to authentication server 106. As discussed in more detail below with reference to FIG. 3, authentication server 106 may use the biometric password 118 to determine whether to authenticate the user to the service provided by server system 108.

Referring now to FIG. 3, a block diagram illustrating an example authentication server 106 is depicted, according to some embodiments. In various embodiments, authentication server 106 is operable to determine whether to authenticate a user of client device 102 to a service (provided, for example, by server system 108) based on one or more biometric passwords 118. Note that, as mentioned above, server system 108 may delegate the process of authenticating the user of client device 102 to authentication server 106. In various embodiments, authentication server 106 is a computer system that is operable to perform authentication operations for various services provided by various server systems (such as server system 108), each of which may have various authorized users. Further note that, although server system 108 and authentication server 106 are discussed separately herein, in various embodiments, server system 108 may be operable to perform some or all of the functionality described with reference to authentication server 106.

In the depicted embodiment, authentication server 106 receives a user identifier 110 from client device 102. For example, client device 102 may send user identifier 110 to authentication server 106 in an attempt to access to a service (e.g., software applications, email services, etc.) provided by a server system 108. In various embodiments, authentication server 106 may use user identifier 110 to retrieve various items of information associated with the user for the particular service to when the user is attempting to access. For example, as noted above, authentication server 106 may receive and store various items of information from client device 102 during an initial registration phase, such as password parameters 112 and a biometric password 118. In various embodiments, authentication server 106 may store the password parameters 112 and biometric passwords 118 in password parameter store 302 and biometric password store 304, respectively. Note that, in various embodiments, password parameter store 302 and biometric password store 304 may be stored on one or more non-transitory, computer-readable storage mediums included in or accessible to authentication server 106.

In various embodiments, authentication server 106 is operable to retrieve password parameters 112 and send them to client device 102 in response to receiving the user identifier 110. In the depicted embodiment, the password parameters 112 include reproduction parameter(s) 204 and security setting 214 so that they may be used by authentication application 103 to generate biometric password 118. Note, however, that in some embodiments, authentication application 103 may generate the biometric password 118 without reliance on a security setting 214 and, in such embodiments, authentication server 106 may not send the security setting 214 to client device 102.

Further in the depicted embodiment, authentication server 106 receives authentication request 116 from client device 102. In various embodiments, authentication request 116 may include user identifier 110 or some other identifier that specifies the user and the service that the user is attempting to access. Additionally, in various embodiments, the authentication request 116 includes biometric password 118. In various embodiments, authentication server 106 is operable to retrieve a stored biometric password 306 associated with the user for the service (provided, for example, by the client device 102 during an initial registration phase).

Authentication server 106 further includes comparator 308, which, in various embodiments, is operable to compare the retrieved biometric password 306 with the biometric password 118 provided in the authentication request 116 and generate an authentication indication 120. In various embodiments, authentication indication 120 may be expressed as a Boolean value, numeric value, or in any other suitable format that specifies the outcome of the comparison performed by the comparator 308. Authentication indication 120 may, in various embodiments, be provided to server system 108 and may indicate whether the user is authenticated to the service. For example, in response to biometric password 118 matching biometric password 306, authentication indication 120 may indicate that the user is authenticated to the service. If, however, biometric password 118 does not match biometric password 306, authentication indication 120 may indicate that the user is not authenticated to the service, and server system 108 or authentication server 106 may take one or more corrective actions, such as denying the user access to the service, initiating additional authentication operations, etc.

### Example Methods

Referring now to FIG. 4, a flow diagram illustrating an example method 400 for an initial registration phase of the disclosed authentication systems and methods is depicted, according to some embodiments. In various embodiments, method 400 may be performed, e.g., by authentication application 103 of FIG. 1, to register to use biometric passwords to access a service provided by server system 108. For example, client device 102 may include (or have access to) a non-transitory, computer-readable medium having program instructions stored thereon that are executable by the client device 102 to cause the operations described with reference to FIG. 4. In FIG. 4, method 400 includes elements 402-408. While these elements are shown in a particular order for ease of understanding, other orders may be used. In various embodiments, some of the method elements may be performed concurrently, in a different order than shown, or may be omitted. Additional method elements may also be performed as desired.

At 402, in the illustrated embodiment, a computer system receives, from a user, a selection of a user identifier and a security setting. For example, client device 102 may receive from a user a selection of a user identifier 110 and a security setting 214. At 404, in the depicted embodiment, the computer system receives user input that includes one or more character-values and one or more biometric readings provided in a particular sequence. For example, client device 102 may receive a selection of a password 114 that includes both one or more character-values 114A and one or more biometric readings 114B provided in a particular sequence.

At 406, in the depicted embodiment, the computer system generates a biometric password based on the user input. For example, in various embodiments, authentication application 103 executing on client device 102 may generate a biometric password 118 based on password 114. In various embodiments, generating the biometric password includes generating a biometric value for each of the one or more biometric readings wherein, for a given biometric reading, a corresponding biometric value is a string of one or more character-values generated based on the given biometric reading. Further, in various embodiments, generating the biometric password includes combining the one or more character-values and the biometric values in an order that corresponds to the particular sequence to generate the biometric password.

In some embodiments, generating a biometric value for each of the one or more biometric readings includes generating, for a given biometric reading, a corresponding biometric key value based on the given biometric reading. For example, in some embodiments, the biometric key values are generated using a fuzzy extractor generation algorithm. Additionally, in some embodiments, generating a biometric value for each of the one or more biometric readings further includes generating, for a given biometric reading, a corresponding reproduction parameter associated with the corresponding key value, wherein the corresponding reproduction parameter may be sent to the authentication server system. For example, in various embodiments, authentication application 103 may generate, during an initial registration phase, a biometric key value 206 and corresponding reproduction parameter 204 for each of the biometric readings 114B in the password 114.

Further, in some embodiments, generating a biometric value for each of the one or more biometric readings includes generating, for a given biometric reading, a corresponding hash value based on the corresponding biometric key value and selecting, for the given biometric reading, a subset of the corresponding hash value as the corresponding biometric value. For example, in some embodiments, a hash value generator 208 may generate a hash value 210 based on the biometric key value 206 and a biometric value selector 212 may select biometric value 216 from the hash value 210, as described in more detail above. In some embodiments, the length of the corresponding biometric value (e.g., biometric value 216) is based on the security setting associated with the user.

At 408, in the illustrated embodiment, the computer system sends, to an authentication server, information specifying the user identifier, the biometric password, and the security setting. For example, in various embodiments, client device 102 may send, to authentication server 106, information specifying user identifier 110, biometric password 118, and security setting 214. Note that, in various embodiments, one or more of the user identifier, the biometric password, and the security setting may be either retained by client device 102 or, rather than being stored by device 102, be provided by authentication server 106 during authentication. Note that, in some embodiments, it may be desirable for client device 102 not to store one or more of the biometric password 118 or user identifier 110 to further increase security in the event that the client device 102 is lost or otherwise compromised.

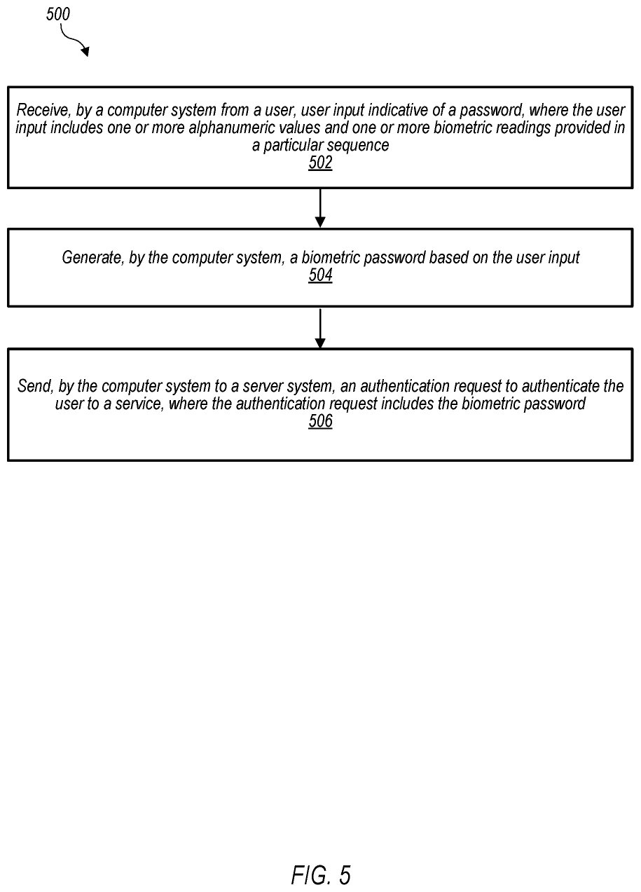

Turning now to FIG. 5, a flow diagram illustrating an example method 500 for generating a biometric password is depicted, according to some embodiments. In various embodiments, method 500 may be performed, e.g., by authentication application 103 of FIG. 1, to generate biometric password 118 to authenticate a user of device 102 to a service provided by server system 108. For example, client device 102 may include (or have access to) a non-transitory, computer-readable medium having program instructions stored thereon that are executable by the client device 102 to cause the operations described with reference to FIG. 5. In FIG. 5, method 500 includes elements 502-506. While these elements are shown in a particular order for ease of understanding, other orders may be used. In various embodiments, some of the method elements may be performed concurrently, in a different order than shown, or may be omitted. Additional method elements may also be performed as desired.

At 502, in the illustrated embodiment, a computer system receives, from a user, user input that includes one or more character-values and one or more biometric readings provided in a particular sequence. With reference to FIG. 2, for example, a user may provide password 114, including character-values 114A and biometric readings 114B, to client device 102 via input device 104. In some embodiments, at least one of the one or more biometric readings corresponds to a fingerprint of the user. For example, in some embodiments, the one or more biometric readings include a first value corresponding to a first fingerprint of the user and a second value corresponding to a second, different fingerprint of the user.

Note that, in some embodiments, the computer system may send, to the server system (e.g., authentication server 106), a request that includes a user identifier associated with the user, and, in response, may receive, from the server system, one or more password parameters associated with the user identifier, wherein the corresponding biometric value is generated based on the one or more password parameters. For example, in some embodiments, client device 102 may send, to authentication server 106, a user identifier 110 that the authentication server 106 may use to retrieve one or more password parameters 112, such as reproduction parameter(s) 204 or security setting 214. Authentication server 106 may then provide these password parameters 112 to client device 102 for use by authentication application 103 to generate biometric password 118.

At 504, in the illustrated embodiment, the computer system generates a biometric password based on the user input. In various embodiments, generating the biometric password includes generating a biometric value for each of the one or more biometric readings wherein, for a given biometric reading, a corresponding biometric value is a string of one or more character-values generated based on the given biometric reading. Further, in various embodiments, generating the biometric value further includes combining the one or more character-values and the biometric values in an order that corresponds to the particular sequence to generate the biometric password. In some embodiments, generating a biometric value for each of the one or more biometric readings includes generating, for the given biometric reading, a corresponding biometric key value based on the given biometric reading and the reproduction parameter. Additionally, in some embodiments, generating a biometric value for each of the one or more biometric readings further includes generating, for a given biometric reading, a corresponding hash value based on the corresponding biometric key value and selecting, for the given biometric reading, a subset of the corresponding hash value as the corresponding biometric value. In some embodiments, the one or more password parameters 112 includes a security setting 214 associated with the user, and a length of the corresponding biometric value (e.g., biometric value 216) is based on the security setting associated with the user.

At 506, in the illustrated embodiment, the computer system sends, to a server system (e.g., authentication server 106) an authentication request to authenticate the user to a service (e.g., provided by server system 108), wherein the authentication request includes the biometric password.

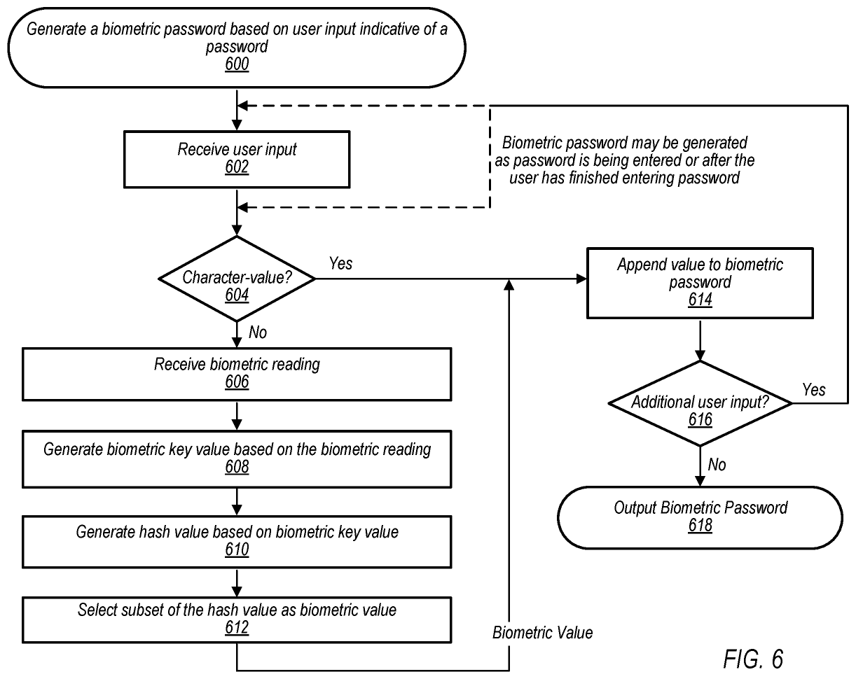

As discussed above, authentication application 103 is operable to generate a biometric password during both an initial registration phase of the disclosed systems and methods and during a subsequent authentication phase in which the user is authenticated such that he or she can access a website or web service. The following description with reference to FIG. 6 discusses a process by which an authentication application 103 may generate a biometric password, according to various embodiments. Note that, in various embodiments, the process used by authentication application 103 to generate biometric passwords during the initial registration phase may differ in certain respects from the process used by application 103 to generate biometric passwords during authentication. Various such differences will be discussed as they arise in the description of FIG. 6.

Referring now to FIG. 6, a flow diagram illustrating an example method 600 for generating a biometric password based on user input is depicted, according to some embodiments. In various embodiments, method 600 may be performed, e.g., by authentication application 103 of FIG. 1, to generate a biometric password 118 during either an initial registration phase or an authentication phase of the disclosed systems and methods. For example, method 600 may correspond to element 406 in method 400 of FIG. 4 or to element 504 in method 500 of FIG. 5. In various embodiments, client device 102 may include (or have access to) a non-transitory, computer-readable medium having program instructions stored thereon that are executable by the client device 102 to cause the operations described with reference to FIG. 6. In FIG. 6, method 600 includes elements 602-618. While these elements are shown in a particular order for ease of understanding, other orders may be used. In various embodiments, some of the method elements may be performed concurrently, in a different order than shown, or may be omitted. Additional method elements may also be performed as desired.

Method 600 begins with element 602, in which the client device 102 receives (e.g., via input device 104) user input indicative of a password 114. As described above, the user input indicative of password 114 may include one or more character-values 114A and one or more biometric readings 114B. Method 600 then proceeds to element 604, which determines whether a first entry in the password 114 is a character-value. If the entry is a character value, then method 600 proceeds to element 614 and that character-value is appended to the biometric password 118. If, however, the entry is not a character-value, method 600 proceeds to element 606, which includes receiving the biometric reading. As noted above, biometric readings 114B in the password 114 may correspond to any one of various suitable biometric sources, such as fingerprints, palm prints, iris patterns, retinal patterns, facial patterns, etc.

Method 600 then proceeds to element 608, which includes generating a biometric key value based on the biometric reading. Note that, in various embodiments, the manner in which the biometric key value(s) are generated by authentication application 103 during the registration phase may differ from the manner in which the biometric key value(s) are generated during authentication. For example, during the initial registration phase, biometric key extractor 202 may use a fuzzy extractor probabilistic generation algorithm that is operable to generate a pair of corresponding values—a biometric key value and corresponding reproduction parameter—for each biometric reading. During authentication, however, biometric key extractor 202 may use a fuzzy extractor deterministic reproduction function, based on the biometric reading and the associated reproduction parameter, to reproduce the biometric key value. Note, however, that this embodiment is provided merely as an example and is not intended to limit the scope of the present disclosure. In other embodiments, biometric key values 206 may be generated using other suitable techniques.

Method 600 then proceeds to element 610, which includes generating a hash value based on the biometric key value. For example, in various embodiments, a hash value generator 208 may generate a hash value 210 based on biometric key value 206 using SHA-2, MD5, or any other suitable hash function. Method 600 then proceeds to element 612, which includes selecting a subset of the hash value as the biometric value. For example, biometric value selector 212 may select biometric value 216 from hash value 210. As noted above, in some embodiments, this selection may be based on a security setting 214 associated with the user, with a higher security setting resulting in a relatively longer biometric value 216.

Method 600 then proceeds to element 614 in which the biometric value is appended to the biometric password. Method 600 then proceeds to element 616, which determines whether there is additional user input included in password 114. If not, then method 600 proceeds to element 618 in which the biometric password 118 is output. In embodiments in which method 600 corresponds to element 406 of FIG. 4, once the biometric password has been output at element 618, method 400 resumes at element 408, as discussed above. In embodiments in which method 600 corresponds to element 504 of FIG. 5, once the biometric password has been output at element 618, method 500 resumes at element 506.

If, however, authentication application 103 determines that there is additional user input at element 616, various elements of method 600 are repeated. As indicated in FIG. 6, biometric password 118 may be generated either as the password 114 is being entered by the user or after the user has finished entering the password 114, according to various embodiments. In various embodiments, elements 604-616 may be repeated until there are no additional entries in the password 114 provided by the user. As noted above, once all of the character-values and biometric values have been combined to generate the biometric password, this biometric password may be used in the registration phase or authentication phase of the disclosed systems and methods.

### Example Computer System

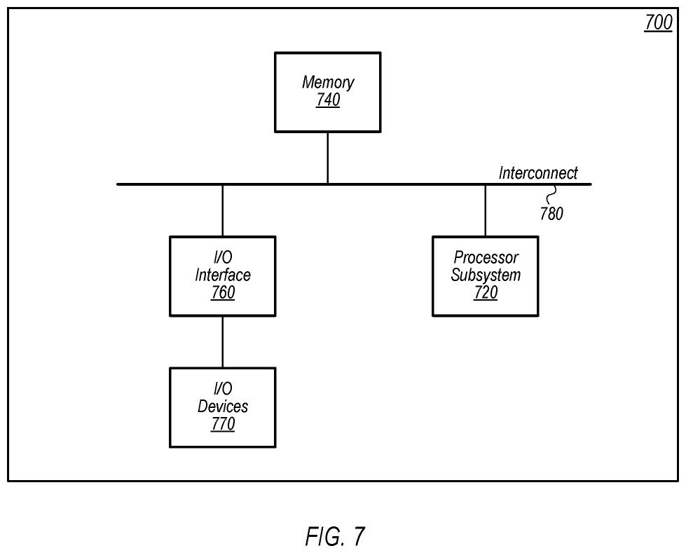

Referring now to FIG. 7, a block diagram of an example computer system 700 is depicted, which may implement one or more computer systems, such as client device 102 or authentication server 106 of FIG. 1, according to various embodiments. Computer system 700 includes a processor subsystem 720 that is coupled to a system memory 740 and I/O interfaces(s) 760 via an interconnect 780 (e.g., a system bus). I/O interface(s) 760 is coupled to one or more I/O devices 770. Computer system 700 may be any of various types of devices, including, but not limited to, a server system, personal computer system, desktop computer, laptop or notebook computer, mainframe computer system, server computer system operating in a datacenter facility, tablet computer, handheld computer, workstation, network computer, etc. Although a single computer system 700 is shown in FIG. 7 for convenience, computer system 700 may also be implemented as two or more computer systems operating together.

Processor subsystem 720 may include one or more processors or processing units. In various embodiments of computer system 700, multiple instances of processor subsystem 720 may be coupled to interconnect 780. In various embodiments, processor subsystem 720 (or each processor unit within 720) may contain a cache or other form of on-board memory.

System memory 740 is usable to store program instructions executable by processor subsystem 720 to cause system 700 perform various operations described herein. System memory 740 may be implemented using different physical, non-transitory memory media, such as hard disk storage, floppy disk storage, removable disk storage, flash memory, random access memory (RAM-SRAM, EDO RAM, SDRAM, DDR SDRAM, RAMBUS RAM, etc.), read only memory (PROM, EEPROM, etc.), and so on. Memory in computer system 700 is not limited to primary storage such as system memory 740. Rather, computer system 700 may also include other forms of storage such as cache memory in processor subsystem 720 and secondary storage on I/O devices 770 (e.g., a hard drive, storage array, etc.). In some embodiments, these other forms of storage may also store program instructions executable by processor subsystem 720.

I/O interfaces 760 may be any of various types of interfaces configured to couple to and communicate with other devices, according to various embodiments. In one embodiment, I/O interface 760 is a bridge chip (e.g., Southbridge) from a front-side to one or more back-side buses. I/O interfaces 760 may be coupled to one or more I/O devices 770 via one or more corresponding buses or other interfaces. Examples of I/O devices 770 include storage devices (hard drive, optical drive, removable flash drive, storage array, SAN, or their associated controller), network interface devices (e.g., to a local or wide-area network), or other devices (e.g., graphics, user interface devices, etc.). In one embodiment, I/O devices 770 includes a network interface device (e.g., configured to communicate over WiFi, Bluetooth, Ethernet, etc.), and computer system 700 is coupled to a network via the network interface device.

Although the embodiments disclosed herein are susceptible to various modifications and alternative forms, specific embodiments are shown by way of example in the figures and are described herein in detail. It should be understood, however, that figures and detailed description thereto are not intended to limit the scope of the claims to the particular forms disclosed. Instead, this application is intended to cover all modifications, equivalents and alternatives falling within the spirit and scope of the disclosure of the present application as defined by the appended claims. The headings used herein are for organizational purposes only and are not meant to be used to limit the scope of the description.

This disclosure includes references to “one embodiment,” “a particular embodiment,” “some embodiments,” “various embodiments,” “an embodiment,” etc. The appearances of these or similar phrases do not necessarily refer to the same embodiment. Particular features, structures, or characteristics may be combined in any suitable manner consistent with this disclosure.

As used herein, the term “based on” is used to describe one or more factors that affect a determination. This term does not foreclose the possibility that additional factors may affect the determination. That is, a determination may be solely based on specified factors or based on the specified factors as well as other, unspecified factors. Consider the phrase “determine A based on B.” This phrase specifies that B is a factor that is used to determine A or that affects the determination of A. This phrase does not foreclose that the determination of A may also be based on some other factor, such as C. This phrase is also intended to cover an embodiment in which A is determined based solely on B. As used herein, the phrase “based on” is synonymous with the phrase “based at least in part on.”

As used herein, the phrase “in response to” describes one or more factors that trigger an effect. This phrase does not foreclose the possibility that additional factors may affect or otherwise trigger the effect. That is, an effect may be solely in response to those factors, or may be in response to the specified factors as well as other, unspecified factors. Consider the phrase “perform A in response to B.” This phrase specifies that B is a factor that triggers the performance of A. This phrase does not foreclose that performing A may also be in response to some other factor, such as C. This phrase is also intended to cover an embodiment in which A is performed solely in response to B.

As used herein, the terms “first,” “second,” etc. are used as labels for nouns that they precede, and do not imply any type of ordering (e.g., spatial, temporal, logical, etc.), unless stated otherwise. When used in the claims, the term “or” is used as an inclusive or and not as an exclusive or. For example, the phrase “at least one of x, y, or z” means any one of x, y, and z, as well as any combination thereof (e.g., x and y, but not z).

It is to be understood that the present disclosure is not limited to particular devices or methods, which may, of course, vary. It is also to be understood that the terminology used herein is for the purpose of describing particular embodiments only and is not intended to be limiting. As used herein, the singular forms “a,” “an,” and “the” include singular and plural referents unless the context clearly dictates otherwise. Furthermore, the word “may” is used throughout this application in a permissive sense (i.e., having the potential to, being able to), not in a mandatory sense (i.e., must). The term “include,” and derivations thereof, mean “including, but not limited to.” The term “coupled” means directly or indirectly connected.

Within this disclosure, different entities (which may variously be referred to as “units,” “circuits,” other components, etc.) may be described or claimed as “configured” to perform one or more tasks or operations. This formulation [entity] configured to [perform one or more tasks] is used herein to refer to structure (i.e., something physical, such as an electronic circuit). More specifically, this formulation is used to indicate that this structure is arranged to perform the one or more tasks during operation. A structure can be said to be “configured to” perform some task even if the structure is not currently being operated. A “memory device configured to store data” is intended to cover, for example, an integrated circuit that has circuitry that performs this function during operation, even if the integrated circuit in question is not currently being used (e.g., a power supply is not connected to it). Thus, an entity described or recited as “configured to” perform some task refers to something physical, such as a device, circuit, memory storing program instructions executable to implement the task, etc. This phrase is not used herein to refer to something intangible.

The term “configured to” is not intended to mean “configurable to.” An unprogrammed FPGA, for example, would not be considered to be “configured to” perform some specific function, although it may be “configurable to” perform that function after programming.

Reciting in the appended claims that a structure is “configured to” perform one or more tasks is expressly intended not to invoke 35 U.S.C. § 112(f) for that claim element. Accordingly, none of the claims in this application as filed are intended to be interpreted as having means-plus-function elements. Should Applicant wish to invoke Section 112(f) during prosecution, it will recite claim elements using the “means for” [performing a function] construct.

In this disclosure, various “modules” operable to perform designated functions are shown in the figures and described in detail above (e.g., biometric key extractor 202, hash value generator 208, biometric password generator 218, etc.). As used herein, the term “module” refers to circuitry configured to perform specified operations or to physical, non-transitory computer-readable media that stores information (e.g., program instructions) that instructs other circuitry (e.g., a processor) to perform specified operations. Such circuitry may be implemented in multiple ways, including as a hardwired circuit or as a memory having program instructions stored therein that are executable by one or more processors to perform the operations. The hardware circuit may include, for example, custom very-large-scale integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices, or the like. A module may also be any suitable form of non-transitory computer readable media storing program instructions executable to perform specified operations.

Although specific embodiments have been described above, these embodiments are not intended to limit the scope of the present disclosure, even where only a single embodiment is described with respect to a particular feature. Examples of features provided in the disclosure are intended to be illustrative rather than restrictive unless stated otherwise. The above description is intended to cover such alternatives, modifications, and equivalents as would be apparent to a person skilled in the art having the benefit of this disclosure.

The scope of the present disclosure includes any feature or combination of features disclosed herein (either explicitly or implicitly), or any generalization thereof, whether or not it mitigates any or all of the problems addressed herein. Accordingly, new claims may be formulated during prosecution of this application (or an application claiming priority thereto) to any such combination of features. In particular, with reference to the appended claims, features from dependent claims may be combined with those of the independent claims and features from respective independent claims may be combined in any appropriate manner and not merely in the specific combinations enumerated in the appended claims.

What is claimed is:

1. A method, comprising:
receiving, by a computer system from a user, user input that includes one or more character-values and one or more biometric readings provided in a particular sequence;
generating, by the computer system, a biometric password based on the user input, including by:
generating a biometric value for each of the one or more biometric readings, wherein, for a given biometric reading, a corresponding biometric value is a string of one or more character-values generated based on the given biometric reading; and
combining the one or more character-values and the biometric values in an order that corresponds to the particular sequence to generate the biometric password; and
sending, by the computer system to a server system, an authentication request to authenticate the user to a service, wherein the authentication request includes the biometric password.

2. The method of claim 1, further comprising:
sending, by the computer system, a request to the server system that includes a user identifier associated with the user; and
receiving, by the computer system from the server system, one or more password parameters associated with the user identifier, wherein the corresponding biometric value is generated based on the one or more password parameters.

3. The method of claim 2, wherein the one or more password parameters includes a reproduction parameter associated with the given biometric reading; and
wherein the generating a biometric value for each of the one or more biometric readings further comprises:
for the given biometric reading, generating a corresponding biometric key value based on the given biometric reading and the reproduction parameter.

4. The method of claim 3, wherein the generating a biometric value for each of the one or more biometric readings further comprises:
generating, for the given biometric reading, a corresponding hash value based on the corresponding biometric key value.

5. The method of claim 4, wherein the generating a biometric value for each of the one or more biometric readings further comprises:
selecting, for the given biometric reading, a subset of the corresponding hash value as the corresponding biometric value.

6. The method of claim 5, wherein the one or more password parameters includes a security setting associated with the user, and wherein a length of the corresponding biometric value is based on the security setting associated with the user.

7. The method of claim 1, wherein at least one of the one or more biometric readings corresponds to a fingerprint of the user.

8. The method of claim 7, wherein the one or more biometric readings include a first value corresponding to a first fingerprint of the user and a second value corresponding to a second, different fingerprint of the user.

9. A non-transitory, computer-readable medium having instructions stored thereon that are executable by a computer system to perform operations comprising:
receiving, from a user, user input that includes one or more character-values and one or more biometric readings provided in a particular sequence;
generating a biometric password based on the user input, including by:
generating a biometric value for each of the one or more biometric readings, wherein, for a given biometric reading, a corresponding biometric value is a string of one or more character-values generated based on the given biometric reading; and
combining the one or more character-values and the biometric values in an order that corresponds to the particular sequence to generate the biometric password; and
sending, to a server system, an authentication request to authenticate the user to a service, wherein the authentication request includes the biometric password.

10. The non-transitory, computer-readable medium of claim 9, wherein the operations further comprise:
sending a request to the server system that includes a user identifier associated with the user; and
receiving, from the server system, one or more password parameters associated with the user identifier, wherein the corresponding biometric value is generated based on the one or more password parameters.

11. The non-transitory, computer-readable medium of claim 10, wherein the one or more password parameters includes a reproduction parameter associated with the given biometric reading; and
wherein the generating a biometric value for each of the one or more biometric readings further comprises:
for the given biometric reading, generating a corresponding biometric key value based on the given biometric reading and the reproduction parameter.

12. The non-transitory, computer-readable medium of claim 11, wherein the generating a biometric value for each of the one or more biometric readings further comprises:
generating, for the given biometric reading, a corresponding hash value based on the corresponding biometric key value.

13. The non-transitory, computer-readable medium of claim 12, wherein the generating a biometric value for each of the one or more biometric readings further comprises:
selecting, for the given biometric reading, a subset of the corresponding hash value as the corresponding biometric value.

14. The non-transitory, computer-readable medium of claim 13, wherein the one or more password parameters includes a security setting associated with the user, and wherein a length of the corresponding biometric value is based on the security setting associated with the user identifier.

15. A method, comprising:
receiving, by a computer system from a user, a selection of a user identifier and a security setting;
receiving, by the computer system, user input that includes one or more character-values and one or more biometric readings provided in a particular sequence;
generating a biometric password based on the user input, including by:
generating a biometric value for each of the one or more biometric readings, wherein, for a given biometric reading, a corresponding biometric value is a string of one or more character-values generated based on the given biometric reading; and
combining the one or more character-values and the biometric values in an order that corresponds to the particular sequence to generate the biometric password; and
sending, by the computer system, information specifying the user identifier, the biometric password, and the security setting to an authentication server system.

16. The method of claim 15, wherein the generating a biometric value for each of the one or more biometric readings further comprises:
for the given biometric reading, generating a corresponding biometric key value based on the given biometric reading.

17. The method of claim 16, wherein the corresponding biometric key value is generated using a fuzzy extractor generation algorithm.

18. The method of claim 17, wherein the generating a biometric value for each of the one or more biometric readings further comprises:
for the given biometric reading, generating a corresponding reproduction parameter associated with the corresponding biometric key value, wherein the corresponding reproduction parameter is sent to the authentication server system.

19. The method of claim 16, the generating a biometric value for each of the one or more biometric readings further comprises:
generating, for the given biometric reading, a corresponding hash value based on the corresponding biometric key value; and
selecting, for the given biometric reading, a subset of the corresponding hash value as the corresponding biometric value.

20. The method of claim 19, wherein a length of the corresponding biometric value is based on the security setting associated with the user.
